(19) United States
(12) Patent Application Publication
(10) Pub. No.: US 2025/0368765 A1
(43) Pub. Date: Dec. 4, 2025

(54) POLYMER EMULSION, ONE-COMPONENT THERMOSETTING RESIN COMPOSITION CONTAINING POLYMER EMULSION, TWO-COMPONENT THERMOSETTING RESIN COMPOSITION CONTAINING POLYMER EMULSION, COATING MATERIAL, RESIN CURED FILM, AND COATING FILM

(71) Applicant: Resonac Corporation, Tokyo (JP)

(72) Inventor: Naoki SEKIOKA, Tokyo (JP)

(73) Assignee: Resonac Corporation, Tokyo (JP)

(21) Appl. No.: 18/875,211

(22) PCT Filed: Aug. 3, 2023
(86) PCT No.: PCT/JP2023/028448

§ 371 Date: Dec. 16, 2024

(30) Foreign Application Priority Data
Aug. 10, 2022 (JP) 2022-128016

(51) Int. Cl. C08F 220/18; C08F 2/26; C08F 2/38; C08L 33/12; C09D 5/02; C09D 133/12

(52) U.S. Cl. CPC C08F 220/18; C08L 33/12; C09D 5/022; C09D 133/12; C08F 2/26; C08F 2/38

(57) ABSTRACT

A polymer emulsion (B) contains a polymer (A) containing a constituent unit (A-1) represented by the following formula (1), and water.

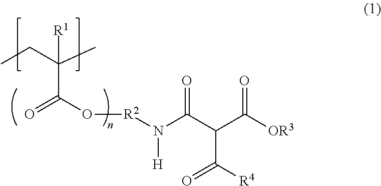

In formula (1), R¹ represents a hydrogen atom or a methyl group, R² represents a di- to tetravalent aliphatic saturated hydrocarbon group having 1 to 20 carbon atoms and containing a straight chain or a branched chain optionally having an ether bond, or a divalent alicyclic hydrocarbon group or aromatic hydrocarbon group having 6 to 20 carbon atoms and optionally having a urethane bond, R³ represents a hydrogen atom, an alkyl group having 1 to 10 carbon atoms, or a cycloalkyl group or arylalkyl group having 6 to 20 carbon atoms, R⁴ represents a hydrogen atom, an alkyl group having 1 to 10 carbon atoms, or a cycloalkyl group or arylalkyl group having 6 to 20 carbon atoms, and n represents 1 or 2.

### TECHNICAL FIELD

The present invention relates to a polymer emulsion, a one-component thermosetting resin composition containing the polymer emulsion, a two-component thermosetting resin composition containing the polymer emulsion, a coating material, a resin cured film, and a coating film.

### BACKGROUND ART

A blocked isocyanate compound is a compound obtained by reacting an isocyanato group of a compound having an isocyanato group with a blocking agent to inactivate (block) the reactivity of the isocyanato group. A blocked isocyanate compound, in which an isocyanato group is blocked, thus is not necessarily prepared and preserved separately from a compound having a functional group reactive with an isocyanato group, such as an active hydrogen group, and can also be prepared and preserved together with such a compound as one component. For this reason, blocked isocyanate compounds are widely used for, for example, adhesives, coating agents, molding materials, and resin compositions.

In recent years, aqueous resin compositions have attracted attention due to the increased awareness of global environment protection.

For example, Patent Literature 1 discloses an acrylic emulsion-based polymer that is obtained by the emulsion polymerization of a monomer mixture containing (meth)acrylic acid alkyl ester as a main component and a hydroxyl group-containing monomer and an active energy ray-curable removable water-dispersible acrylic adhesive composition composed of a compound having a radical polymerizable unsaturated bond and a blocked isocyanate group in the molecule.

Patent Literature 2 discloses a copolymer containing a constituent unit (a) having a group represented by a predetermined formula, a constituent unit (b) having a hydroxy group, and a constituent unit (c) having an acid group, and having a glass transition temperature of 30° C. or lower.

### CITATION LIST

### Patent Literature

[Patent Literature 1] JP5132096B
[Patent Literature 2] WO22/138159

### SUMMARY OF INVENTION

### Technical Problem

In Patent Literature 1, the active energy ray-curable removable water-dispersible acrylic adhesive composition is applied onto a support, such as a base material, to form an adhesive composition layer, and the adhesive composition layer is then heated and dried to form an adhesive layer. Due to this heating, an isocyanate block is deprotected from the compound having a radical polymerizable unsaturated bond and a blocked isocyanate group to generate an isocyanate group, and the generated isocyanate group and the hydroxyl group in the acrylic emulsion-based polymer react with each other, whereby an acrylic polymer having a radical polymerizable unsaturated bond as a side chain of the polymer, which forms the adhesive layer, is obtained. However, in the adhesive composition before heating, since the compound having a radical polymerizable unsaturated bond and a blocked isocyanate group is present as a monomer, the blocked isocyanate group is likely to react with water and is unstable, and there has been a room for improvement from the viewpoint of preservation stability.

In Patent Literature 2, the object is to provide a resin composition from which a cured product having excellent solvent resistance can be obtained, and it is disclosed that a solvent having a strong effect of impairing the transesterification reaction with a hydroxy group, such as a primary and/or secondary alcohol solvent or an ether-based solvent, is preferably used as a solvent. However, there have been no studies conducted regarding, for example, the preservation stability of the resin composition in the case of using water as the solvent. Therefore, there has been a room for improvement from the viewpoint of preservation stability in aqueous resin compositions.

The present invention has been made for solving the problems described above, and an object of the present invention is to provide a polymer emulsion having excellent preservation stability, a thermosetting resin composition containing the polymer emulsion, and having excellent curability, a coating material containing the thermosetting resin composition, a resin cured film obtained by curing the thermosetting resin composition, and a coating film including the resin cured film.

### Solution to Problem

The present invention includes the following aspects [1] to [14].
[1] A polymer emulsion (B) comprising a polymer (A) containing a constituent unit (A-1) represented by the following formula (1), and water:

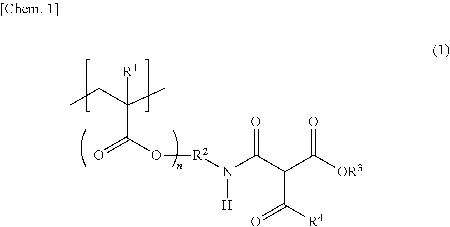

wherein R¹ represents a hydrogen atom or a methyl group, R² represents a di- to tetravalent aliphatic saturated hydrocarbon group having 1 to 20 carbon atoms and containing a straight chain or a branched chain optionally having an ether bond, or a divalent alicyclic hydrocarbon group or aromatic hydrocarbon group having 6 to 20 carbon atoms and optionally having a urethane bond, R³ represents a hydrogen atom, an alkyl group having 1 to 10 carbon atoms, or a cycloalkyl group or arylalkyl group having 6 to 20 carbon atoms, R⁴ represents a hydrogen atom, an alkyl group having 1 to 10 carbon atoms, or a cycloalkyl group or arylalkyl group having 6 to 20 carbon atoms, and n represents 1 or 2.
[2] The polymer emulsion (B) according to [1], wherein a content ratio of the constituent unit (A-1) when a total content of all constituent units of the polymer (A) is defined as 100 mol % is 0.1 mol % or more and 40 mol % or less.
[3] The polymer emulsion (B) according to [1] or [2], wherein the polymer (A) contains a constituent unit (A-2) represented by the following formula (2) as a constituent unit of the polymer (A):

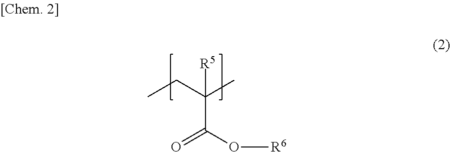

wherein R⁵ represents a hydrogen atom, or an aliphatic saturated hydrocarbon group having 1 to 4 carbon atoms and containing a straight chain or a branched chain; R⁶ represents an aliphatic saturated hydrocarbon group having 1 to 18 carbon atoms in which a hydrogen atom is optionally replaced by a hydroxy group, an acyl group, an alkoxy group, a carboxy group, a thiol group, a sulfo group, a nitro group, an amino group, a chlorine atom, a fluorine atom, a bromine atom, an iodine atom, or an astatine atom, and is free of an aromatic ring.
[4] The polymer emulsion (B) according to any one of [1] to
[3], wherein the polymer (A) further contains a constituent unit (A-3) represented by the following formula (3) as a constituent unit of the polymer:

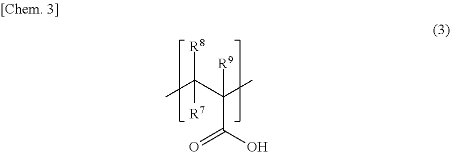

wherein R⁷, R⁸, and R⁹ each independently represent a hydrogen atom, or a hydrocarbon group containing a straight chain or a branched chain having 1 to 15 carbon atoms and optionally containing an ester bond and/or a carboxy group.
[5] The polymer emulsion (B) according to any one of [1] to [4], wherein, in the constituent unit (A-1), n is 1, and R² is a divalent aliphatic saturated hydrocarbon group having 2 to 4 carbon atoms and optionally having an ether bond.
[6] A one-component thermosetting resin composition (F) comprising the polymer emulsion (B) according to any of [3] to [5], wherein at least one hydrogen atom of R⁶ in the constituent unit (A-2) is replaced by a hydroxy group.
[7] A coating material (G) comprising the one-component thermosetting resin composition (F) according to [6].
[8] A resin cured film (H) obtained by curing the one-component thermosetting resin composition (F) according to [6].
[9] A coating film (I) comprising the resin cured film (H) according to [8].
[10] A two-component thermosetting resin composition (K) comprising the polymer emulsion (B) according to any one of [1] to [5], and an acrylic polyol polymer emulsion (J).
[11] The two-component thermosetting resin composition (K) according to [10], wherein a ratio between the number of moles of R³ in the constituent unit (A-1) in the polymer emulsion (B) and the number of moles of hydroxyl groups in the acrylic polyol polymer emulsion (J) is 2:1 to 1:4.
[12] A coating material (L) comprising the two-component thermosetting resin composition (K) according to [10] or [11]
[13] A resin cured film (M) obtained by curing the two-component thermosetting resin composition (K) according to any of [10] or [11].
[14] A coating film (N) comprising the resin cured film (M) according to [13].

### Advantageous Effects of Invention

According to the present invention, it is possible to provide a polymer emulsion having excellent preservation stability, a thermosetting resin composition containing the polymer emulsion, and having excellent curability, a coating material containing the thermosetting resin composition, a resin cured film obtained by curing the thermosetting resin composition, and a coating film including the resin cured film.

### DESCRIPTION OF EMBODIMENT

Hereinafter, embodiments of the present invention will be described in detail. However, it should be understood that the present invention is not limited to the embodiments shown below.

A substance expressed as (meth)acrylate in the present specification means any of acrylate and methacrylate. A substance expressed as (meth)acrylic acid means any of acrylic acid and methacrylic acid.

### <Polymer Emulsion (B)>

An embodiment of the present invention is a polymer emulsion (B) containing a polymer (A) containing a constituent unit (A-1) represented by the following formula (1), and water.

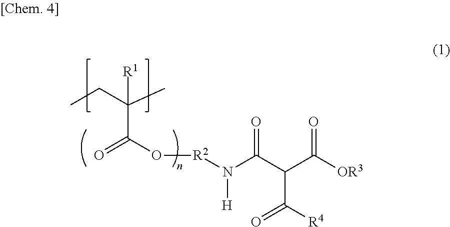

In formula (1), R¹ represents a hydrogen atom or a methyl group. R² represents a di- to tetravalent aliphatic saturated hydrocarbon group having 1 to 20 carbon atoms and containing a straight chain or a branched chain optionally having an ether bond, or a divalent alicyclic hydrocarbon group or aromatic hydrocarbon group having 6 to 20 carbon atoms and optionally having a urethane bond.

R³ represents a hydrogen atom, an alkyl group having 1 to 10 carbon atoms, or a cycloalkyl group or arylalkyl group having 6 to 20 carbon atoms.

R⁴ represents a hydrogen atom, an alkyl group having 1 to 10 carbon atoms, or a cycloalkyl group or arylalkyl group having 6 to 20 carbon atoms.
n represents 1 or 2.

### [Polymer (A)]

The polymer (A) contains a constituent unit (A-1) represented by the formula (1) (hereinafter, also referred to as “constituent unit (A-1)”). Preferably, the polymer (A) further contains a constituent unit (A-2) represented by formula (2) described below (hereinafter, also referred to as a “constituent unit (A-2)”) and/or a constituent unit (A-3) represented by formula (3) described below (hereinafter, also referred to as a “constituent unit (A-3)”).

### [Constituent Unit (A-1)]

The constituent unit (A-1) is represented by the formula (1).

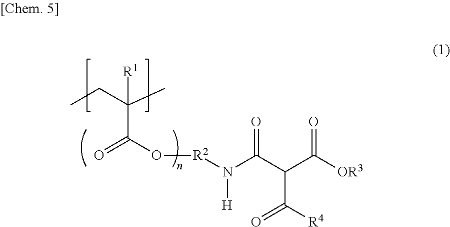

In formula (1), R¹ represents a hydrogen atom or a methyl group. R² represents a di- to tetravalent aliphatic saturated hydrocarbon group having 1 to 20 carbon atoms and containing a straight chain or a branched chain optionally having an ether bond, or a divalent alicyclic hydrocarbon group or aromatic hydrocarbon group having 6 to 20 carbon atoms and optionally having a urethane bond, preferably represents a divalent aliphatic saturated hydrocarbon group having 2 to 4 carbon atoms and optionally having an ether bond, and is more preferably —CH₂CH₂—.

R³ represents a hydrogen atom, an alkyl group having 1 to 10 carbon atoms, or a cycloalkyl group or arylalkyl group having 6 to 20 carbon atoms, preferably represents an alkyl group having 1 to 8 carbon atoms, more preferably represents a methyl group or an ethyl group, and is particularly preferably an ethyl group.

R⁴ represents a hydrogen atom, an alkyl group having 1 to 10 carbon atoms and preferably having 1 to 8 carbon atoms, or a cycloalkyl group or arylalkyl group having 6 to 20 carbon atoms, more preferably represents an alkyl group having 1 to 8 carbon atoms, more preferably represents a methyl group or an ethyl group, and is particularly preferably an ethyl group.
n represents 1 or 2, and is preferably 1.

In a case where R³ is an ethyl group, when a one-component thermosetting resin composition (F) or two-component thermosetting resin composition (K) containing the polymer (A) is thermally cured, R³ undergoes transesterification with the constituent unit (A-2) or a hydroxy group in an acrylic polyol polymer emulsion (J), which will be described below, and ethanol is generated. The ethanol generated during the thermal curing of the resin composition is easily evaporated and removed by heating for thermally curing the resin composition, which is preferable.

The constituent unit (A-1) is preferably a constituent unit derived from a monomer obtained by blocking an isocyanate monomer (a-1-1) with a blocking agent (a-1-2) (hereinafter, also referred to as a “blocked isocyanate compound”).

The isocyanate monomer (a-1-1) is preferably represented by the following formula (4).

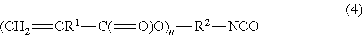

In formula (4), R¹, R² and n have the same meanings as the symbols in formula (1).

Examples of the isocyanate monomer (a-1-1) represented by formula (4) include a (meth)acrylic acid ester compound having an isocyanato group, and an adduct of hydroxyl group-containing (meth)acrylate and a diisocyanate compound at 1:1 (molar ratio).

Examples of the (meth)acrylic acid ester compound having an isocyanato group include 2-(meth)acryloyloxyethyl isocyanate, 3-(meth)acryloyloxy-n-propyl isocyanate, 2-(meth)acryloyloxyisopropyl isocyanate, 4-(meth)acryloyloxy-n-butyl isocyanate, 2-(meth)acryloyloxy-tert-butyl isocyanate, 2-(meth)acryloyloxybutyl-4-isocyanate, 2-(meth)acryloyloxybutyl-3-isocyanate, 2-(meth)acryloyloxybutyl-2-isocyanate, 2-(meth)acryloyloxybutyl-1-isocyanate, 5-(meth)acryloyloxy-n-pentyl isocyanate, 6-(meth)acryloyloxy-n-hexyl isocyanate, 7-(meth)acryloyloxy-n-heptyl isocyanate, 2-(isocyanatoethyloxy)ethyl (meth)acrylate, 3-(meth)acryloyloxyphenyl isocyanate, 4-(meth)acryloyloxyphenyl isocyanate, 1,1-bis((meth)acryloyloxymethyl)methyl isocyanate, and 1,1-bis(meth)acryloyloxymethyl)ethyl isocyanate.

Examples of the hydroxyl group-containing (meth)acrylate include 2-hydroxyalkyl (meth)acrylate. An alkyl group of 2-hydroxyalkyl (meth)acrylate is preferably an ethyl group or a n-propyl group, and more preferably an ethyl group.

Examples of the diisocyanate compound include hexamethylene diisocyanate, 2,4-(or 2,6-)tolylene diisocyanate (TDI), 4,4′-diphenylmethane diisocyanate (MDI), 3,5,5-trimethyl-3-isocyanatomethylcyclohexyl isocyanate (IPDI), m-(or p-)xylene diisocyanate, 1,3-(or 1,4-)bis(isocyanatomethyl)cyclohexane, and lysine diisocyanate.

Of these, from the viewpoint of ease of production and/or availability of raw materials, 2-(meth)acryloyloxyethyl isocyanate, 2-(isocyanatoethyloxy)ethyl (meth)acrylate, or 1,1-bis((meth)acryloyloxymethyl)ethyl isocyanate is preferable, and 2-(meth)acryloyloxyethyl isocyanate is more preferable.

Examples of the blocking agent (a-1-2) include methyl acetoacetate, ethyl acetoacetate, propyl acetoacetate, butyl acetoacetate, pentyl acetoacetate, methyl 3-oxohexanoate, ethyl 3-oxohexanoate, methyl 3-oxovalerate, and ethyl 3-oxovalerate, and of these, methyl acetoacetate, and ethyl acetoacetate are preferable.

The blocked isocyanate compound can be produced by a known method. The production can be performed by, for example, reacting the isocyanate monomer (a-1-1) and the blocking agent (a-1-2) in a reaction container by one of the following methods (i) to (iii).
(i) A reaction vessel is charged with the blocking agent (a-1-2), and the isocyanate monomer (a-1-1) is added with stirring to react the mixture
(ii) A reaction vessel is charged with the isocyanate monomer (a-1-1), and the blocking agent (a-1-2) is added with stirring to react the mixture
(iii) Both the blocking agent (a-1-2) and the isocyanate monomer (a-1-1) are simultaneously added into a reaction vessel with stirring to react the mixture

The reaction temperature is not particularly limited, and can be appropriately set according to the types of the isocyanate monomer (a-1-1) and the blocking agent (a-1-2) and the amount ratio thereof, but is, for example, preferably −10° C. or higher and 90° C. or lower, and more preferably 5° C. or higher and 70° C. or lower. The reaction time is not particularly limited, and can be appropriately set, but is preferably 30 minutes or more and 168 hours or less.

As the blocked isocyanate compound, a commercially available product can also be used. Examples of the commercially available product include KARENZ® MOI-OBE, KARENZ® AOI-OBE, KARENZ® MOI-OBM, and KARENZ® AOI-OBM manufactured by Showa Denko Materials Co., Ltd.

The constituent unit (A-1) may be of one type or a combination of two or more types.

The content of the constituent unit (A-1) when the total content of the constituent units (A-1) to (A-4) (hereinafter, also referred to as “all constituent units”) of the polymer (A) is defined as 100 mol % is preferably 0.1 mol % or more, more preferably 0.5 mol % or more, further preferably 1.0 mol % or more, and particularly preferably 2.0 mol % or more, and preferably 40.0 mol % or less, more preferably 20.0 mol % or less, further preferably 10.0 mol % or less, and particularly preferably 5.0 mol % or less.

### [Constituent Unit (A-2)]

The polymer (A) preferably contains the constituent unit (A-2). The constituent unit (A-2) is represented by the following formula (2).

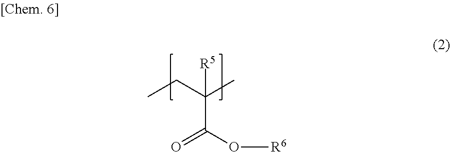

In formula (2), R⁵ represents a hydrogen atom, or an aliphatic saturated hydrocarbon group having 1 to 4 carbon atoms and containing a straight chain or a branched chain. R⁶ represents an aliphatic saturated hydrocarbon group having 1 to 18 carbon atoms in which a hydrogen atom is optionally replaced by a hydroxy group, an acyl group, an alkoxy group, a carboxy group, a thiol group, a sulfo group, a nitro group, an amino group, a chlorine atom, a fluorine atom, a bromine atom, an iodine atom, or an astatine atom, and is free of an aromatic ring.

The constituent unit (A-2) cannot be contained in the constituent unit (A-1).

The constituent unit (A-2) is preferably a constituent unit derived from a monomer (a-2). The monomer (a-2) is preferably an ester compound from a carboxylic acid compound (a-2-1) and R⁶—OH (a-2-2).

The carboxylic acid compound (a-2-1) is preferably (meth)acrylic acid.

In R⁶—OH (a-2-2), R⁶ has the same meaning as the symbol in formula (2). Examples of R⁶ include a methyl group, an ethyl group, an n-butyl group, an i-butyl group, a sec-butyl group, a t-butyl group, an n-propyl group, an i-propyl group, a 2-ethylhexyl group, and an n-dodecyl group, and a methyl group, an ethyl group, a butyl group, a propyl group, and a 2-ethylhexyl group are preferable.

Examples of the monomer (a-2) include methyl (meth)acrylate, ethyl (meth)acrylate, propyl (meth)acrylate, butyl (meth)acrylate, and 2-ethylhexyl (meth)acrylate.

The constituent unit (A-2) may be of one type or a combination of two or more types.

The content of the constituent unit (A-2) when the total content of all constituent units of the polymer (A) is defined as 100 mol % is preferably 0 mol % or more, more preferably 3.0 mol % or more, and further preferably 10.0 mol % or more, and preferably 99.9 mol % or less, more preferably 95.0 mol % or less, and further preferably 70.0 mol % or less.

### [Constituent Unit (A-3)]

The polymer (A) preferably contains the constituent unit (A-3). The constituent unit (A-3) is represented by the following formula (3).

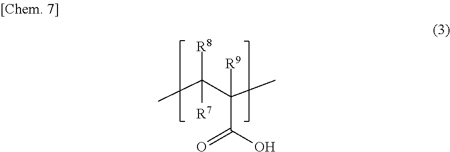

In formula (3), R⁷, R⁸, and R⁹ each independently represent a hydrogen atom, or a hydrocarbon group containing a straight chain or a branched chain having 1 to 15 carbon atoms, preferably having 1 to 6 carbon atoms, and optionally containing an ester bond and/or a carboxy group.

The constituent unit (A-3) represented by formula (3) is preferably a constituent unit derived from a monomer (a-3). Examples of the monomer (a-3) include unsaturated monocarboxylic acids such as (meth)acrylic acid, crotonic acid, 2-pentenoic acid and cinnamic acid; unsaturated dicarboxylic acids such as fumaric acid, maleic acid and itaconic acid; butenedioic acid mono-chain alkyl esters such as monomethyl fumarate, monoethyl fumarate, mono-n-butyl fumarate, monomethyl maleate, monoethyl maleate, mono(2-ethylhexyl) maleate and mono-n-butyl maleate; butenedioic acid monocyclic alkyl esters such as monocyclopentyl fumarate, monocyclohexyl fumarate, monocyclopentyl maleate and monocyclohexyl maleate; itaconic acid monoesters such as monomethyl itaconate, monoethyl itaconate, mono-n-butyl itaconate and monocyclohexyl itaconate. Of these, for example, (meth)acrylic acid, unsaturated dicarboxylic acid monoesters such as monoethyl fumarate, monopropyl fumarate, monobutyl fumarate, monoethyl itaconate, monopropyl itaconate, and monobutyl itaconate are preferable, and (meth)acrylic acid is more preferable.

The constituent unit (A-3) may be of one type or a combination of two or more types.

The content of the constituent unit (A-3) when the total content of all constituent units of the polymer (A) is defined as 100 mol % is preferably 0 mol % or more, more preferably 0.1 mol % or more, and further preferably 0.3 mol % or more, and preferably 20.0 mol % or less, more preferably 15.0 mol % or less, and further preferably 5.0 mol % or less.

### [Further Constituent Unit (A-4)]

The polymer (A) of the present embodiment may also contain, in addition to the constituent units (A-1) to (A-3), a further constituent unit (A-4) capable of being copolymerized with the constituent units (A-1) to (A-3) (here, constituent units corresponding to the constituent units (A-1) to (A-3) are excluded) as necessary.

The further constituent unit (A-4) can be derived from a monomer (a-4) that gives the further constituent unit (A-4). Examples of the monomer (a-4) include aromatic vinyl compounds such as styrene, α-methylstyrene, and p-methylstyrene, unsaturated sulfonic acids such as p-styrenesulfonic acid and salts thereof, anhydrides of unsaturated carboxylic acids such as maleic anhydride, and vinyl compounds such as vinyl acetate and vinyl chloride.

### [Method for Producing Polymer Emulsion (B)]

The polymer emulsion (B), which is an embodiment of the present invention, can be produced by, for example, mixing the monomer (a-1) together with water or produced by performing polymerization in an organic solvent, then, emulsifying a polymer by adding a surfactant and water, and distilling the solvent away and is preferably produced by emulsion polymerization. The production of the polymer emulsion (B) by emulsion polymerization can be performed by a known method. For example, the polymer emulsion can be produced by preparing a monomer emulsion in which a monomer and water have been emulsified and dispersed in advance preferably using a surfactant, subsequently, heating water, preferably a mixture of water and a surfactant, in a container different from the container for the monomer emulsion, then, adding the previously-prepared monomer emulsion thereto dropwise, and preferably adding a radical polymerization initiator as appropriate thereto to perform emulsion polymerization. The reaction temperature or the reaction time can be appropriately set according to the type and the amount of the monomer used.

The monomer (a-2) and/or the monomer (a-3) may be used in production of the polymer emulsion (B).

Regarding the amounts of the monomer (a-1) that is used in production of the polymer emulsion (B), the monomer (a-2) and the monomer (a-3) that are preferably used in the production, and the monomer (a-4) that gives the further constituent unit (A-4) blended, when the amount of all of these monomers is defined as 100 mol %, the monomer (a-1) is preferably 0.1 mol % or more, more preferably 0.5 mol % or more, further preferably 1.0 mol % or more, and particularly preferably 2.0 mol % or more and is preferably 40.0 mol % or less, more preferably 20.0 mol % or less, further preferably 10.0 mol % or less, and particularly preferably 5.0 mol % or less.

The amount of the monomer (a-2) blended when the amount of all of the monomers is defined as 100 mol % is preferably 0 mol % or more, more preferably 3.0 mol % or more, and further preferably 10.0 mol % or more, and preferably 99.9 mol % or less, more preferably 95.0 mol % or less, and further preferably 70.0 mol % or less.

The amount of the monomer (a-3) blended when the amount of all of the monomers is defined as 100 mol % is preferably 0 mol % or more, more preferably 0.1 mol % or more, and further preferably 0.3 mol % or more, and preferably 20.0 mol % or less, more preferably 15.0 mol % or less, and further preferably 5.0 mol % or less.

The amount of each of the monomers blended is substantially identical to the content of each of the constituent units when the total content of all constituent units of the polymer (A) is defined as 100 mol %.

The value of functional group equivalent÷Mn of the polymer emulsion (B) is preferably 0.001 or more, more preferably 0.01 or more, and further preferably 0.05 or more. When the value of functional group equivalent÷Mn is 0.001 or more, the density of crosslinking points is relatively large, and crosslinking is likely to progress, which is preferable. The value of functional group equivalent÷Mn of the polymer emulsion (B) is preferably 10 or less, more preferably 5.0 or less, further preferably 3.0 or less, and further particularly preferably 0.8 or less. When the value of functional group equivalent÷Mn is 10 or less, the density of crosslinking points is relatively large, and crosslinking is likely to progress, which is preferable. Mn represents the number average molecular weight of the polymer (A) in the polymer emulsion (B).

The functional group equivalent can be obtained by the following formula.

(Molecular weight of constituent unit (A-1))÷(parts by mass of constituent unit (A-1))×100

In a case where there are two or more types of constituent units (A-1), the value of functional group equivalent÷Mn is a value obtained by calculating and adding the functional group equivalent of each of the constituent units (A-1) by the above formula and dividing the total by the number average molecular weight of the polymer (A).

The solvent of the polymer emulsion (B) is water. The solvent may contain 1 mass % or less of a solvent compatible with water. Examples of the solvent compatible with water include alcohols such as methanol, ethanol and isopropanol; ethers such as ethylene glycol monomethyl ether and propylene glycol monoethyl ether; ketones such as acetone and methyl ethyl ketone.

The polymer emulsion (B) is preferably produced in the presence of a surfactant (C), a chain transfer agent (D), and a polymerization initiator (E).

### [Surfactant (C)]

The polymer emulsion (B) is preferably produced in the presence of a surfactant (C). The surfactant is not particularly limited. It is possible to use one or more of a nonionic emulsifier, an anionic emulsifier and a reactive surfactant that are commonly used. The surfactant (C) is preferably an anionic emulsifier or a reactive surfactant, and more preferably a reactive surfactant from the viewpoint of suppressing bleed-out of the surfactant to the surface after drying of the polymer emulsion.

Examples of the nonionic emulsifier include polyoxyethylene alkyl ether, polyoxyethylene alcohol ether, polyoxyethylene alkyl phenyl ether, polyoxyethylene polycyclic phenyl ether, polyoxyalkylene alkyl ether, a sorbitan fatty acid ester, a polyoxyethylene fatty acid ester, and a polyoxyethylene sorbitan fatty acid ester.

Examples of the anionic emulsifier include an alkylbenzene sulfonic acid salt, an alkyl sulfuric acid ester salt, a polyoxyethylene alkyl ether sulfuric acid ester salt, a polyoxyalkylene alkyl ether phosphoric acid ester or a salt thereof, a polyoxyalkylene alkyl phenyl ether phosphoric acid ester or a salt thereof, and a fatty acid salt, and examples of the salt include alkali metals such as sodium and potassium, ammonia, and amines.

Examples of the reactive surfactant include structures of formulae (5) to (7).

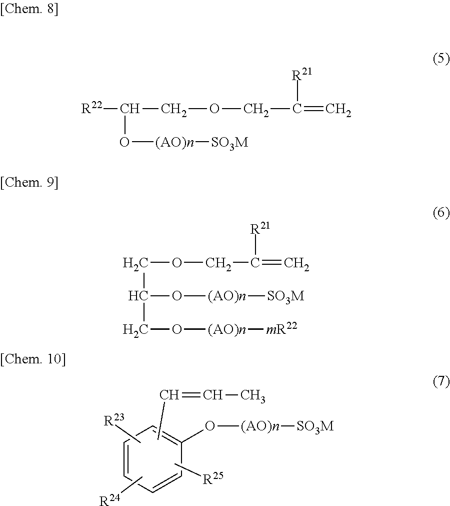

In formulae (5) to (7), R²¹, R²³, R²⁴ and R²⁵ are each independently hydrogen or an alkyl group, R²² is, for example, an alkyl group or an alkyl phenyl group, A represents an alkylene group such as —CH₂—CH₂—, M represents an ammonium salt, or a salt of a metal such as potassium or sodium, n represents an integer of 2 to 20, and m represents an integer of 0 to 20.

Examples of a compound represented by formula (5) include AQUALON® KH-10 and KH-5 (manufactured by DKS Co. Ltd.). Examples of a compound represented by formula (6) include ADEKA REASOAP® SE-10N (manufactured by ADEKA CORPORATION). Examples of a compound represented by formula (7) include AQUALON® HS-10 (manufactured by DKS Co. Ltd.).

From the viewpoint that particle stability during polymerization can be secured and an increase in viscosity can be suppressed, the surfactant (C) is preferably contained at 0.1 mass % or more and 10.0 mass % or less, more preferably contained at 0.3 mass % or more and 7.0 mass % or less, and further preferably contained at 0.5 mass % or more and 5.0 mass % or less with respect to the solid content of the polymer (A).

### [Chain Transfer Agent (D)]

A chain transfer agent (D) can be used as necessary for adjusting the molecular weight of the polymer (A). The chain transfer agent (D) is not particularly limited, and examples thereof include alkyl mercaptans such as n-hexyl mercaptan, n-octyl mercaptan, t-octyl mercaptan, n-dodecyl mercaptan, t-dodecyl mercaptan and n-stearyl mercaptan; 2,4-diphenyl-4-methyl-1-pentene, 2,4-diphenyl-4-methyl-2-pentene; xanthogen compounds such as dimethyl xanthogen disulfide and diisopropyl xanthogen disulfide; terpinolene; thiuram-based compounds such as tetramethylthiuram disulfide, tetraethylthiuram disulfide and tetramethylthiuram monosulfide; phenolic compounds such as 2,6-di-t-butyl-4-methyl phenol and styrenated phenol; allyl compounds such as allyl alcohol; halogenated hydrocarbon compounds such as dichloromethane, dibromomethane and carbon tetrabromide; vinyl ether such as α-benzyloxystyrene, α-benzyloxyacrylonitrile and α-benzyloxyacrylamide; and triphenylethane, pentaphenylethane, acrolein, methacrolein, thioglycolic acid, thiomalic acid, and 2-ethylhexyl thioglycolate. One of these compounds, or two or more thereof may be used. The amount of the chain transfer agent used is not particularly limited, but is typically 0 to 5.0 mass % with respect to the solid content of the polymer (A).

### [Polymerization Initiator (E)]

The polymer emulsion (B) is preferably produced in the presence of a polymerization initiator (E). The polymerization initiator and a reducing agent may be combined, and used as a redox polymerization initiator. As reducing agent, for example, potassium hydrogensulfite, sodium bisulfite, potassium sulfite or sodium sulfite can be used.

The polymerization initiator (E) is not particularly limited, and examples thereof include inorganic polymerization initiators typified by persulfates such as potassium persulfate, sodium persulfate and ammonium persulfate; organic peroxide-based polymerization initiators such as 2,2-di(4,4-di-(t-butylperoxy)cyclohexyl)propane, 1-di-(t-hexylperoxy)cyclohexane, 1,1-di-(t-butylperoxy)cyclohexane, n-butyl 4,4-di-(t-butylperoxy)valerate, 2,2-di(t-butylperoxy)butane, t-butyl hydroperoxide, cumene hydroperoxide, benzoyl peroxide, diisopropylbenzene hydroperoxide, p-menthane hydroperoxide, 1,1,3,3-tetramethylbutyl hydroperoxide, t-butylcumyl peroxide, di-t-butyl peroxide, di-t-hexyl peroxide, di(2-t-butylperoxyisopropyl)benzene, dicumyl peroxide, diisobutyryl peroxide, di(3,5,5-trimethylhexanoyl)peroxide, dilauroyl peroxide, disuccinic acid peroxide, dibenzoyl peroxide, di(3-methylbenzoyl) peroxide, benzoyl(3-methylbenzoyl) peroxide, diisopropyl peroxydicarbonate, di-n-propyl peroxydicarbonate, di(4-t-butylcyclohexyl) peroxydicarbonate, di(2-ethylhexyl) peroxydicarbonate, di-sec-butyl peroxydicarbonate, cumyl peroxyneodecanate, 1,1,3,3-tetramethylbutyl peroxyneodecanate, t-hexyl peroxyneodecanate, t-butyl peroxyneodecanate, t-hexyl peroxypivalate, t-butyl peroxypivalate, 2,5-dimethyl-2,5-di(2-ethylhexanoylperoxy)hexane, 1,1,3,3-tetramethylbutyl peroxy-2-ethylhexanate, t-hexyl peroxy-2-ethylhexanate, t-butyl peroxy-2-ethylhexanate, t-butyl peroxylaurate, t-butyl peroxy-3,5,5-trimethylhexanate, t-hexyl peroxyisopropylmonocarbonate, t-butyl peroxyisopropylmonocarbonate, t-butyl peroxy-2-ethylhexylmonocarbonate, 2,5-dimethyl-2,5-di(benzoylperoxy)hexane, t-butyl peroxyacetate, t-hexyl peroxybenzoate, t-butyl peroxybenzoate and 2,5-dimethyl-2,5-di(t-butylperoxy)hexane; and azo-based initiators such a hydroperoxide, azobisisobutyronitrile, dimethyl 2,2′-azobis(isobutyrate), 4,4′-azobis(4-cyanovaleric acid), 2-2′-azobis[2-(2-imidazolin-2-yl)propane, 2-2′-azobis(propane-2-carboamidine)2-2′-azobis[N-(2-carboxyethyl)-2-methylpropanamide, 2,2′-azobis{2-[1-(2-hydroxyethyl)-2-imidazolin-2-yl]propane}, 2-2′-azobis(1-imino-1-pyrrolidino-2-methylpropane) and 2,2′-azobis{2-methyl-N-[1,1-bis(hydroxymethyl)-2-hydroxyethyl]propaneamide}. These polymerization initiators may be used singly, or in combination or two or more thereof. The polymerization initiator (E) is preferably potassium persulfate, sodium persulfate, ammonium persulfate, t-butyl hydroperoxide, cumene hydroperoxide, benzoyl peroxide, hydroperoxide, azobisisobutyronitrile, or dimethyl 2,2′-azobis(isobutyrate), and potassium persulfate, sodium persulfate and ammonium persulfate are more preferable because they have good solubility in water.

The polymerization initiator (E) is preferably contained at 0.01 mass % or more and 5 mass % or less, more preferably contained at 0.03 mass % or more and 4 mass % or less, and further preferably contained at 0.05 mass % or more and 3 mass % or less with respect to the solid content of the polymer (A). When the content of the polymerization initiator (E) is within the above-described range, the amount of residual monomers after reaction can be reduced, and influences of a polymerization initiator-derived structure on physical properties can also be suppressed, which is preferable.

In an aspect of the present invention, the polymer emulsion (B) may contain a basic salt containing an acid having a pKa of 2 or more and an alkali metal.

Examples of the acid having a pKa of 2 or more include carbonic acid, acetic acid, nitrous acid, sulfurous acid, phosphoric acid, and boric acid.

The alkali metal is preferably lithium, sodium, potassium, rubidium, or cesium and more preferably sodium or potassium.

Examples of the basic salt containing an acid having a pKa of 2 or more and an alkali metal include lithium carbonate, sodium carbonate, potassium carbonate, rubidium carbonate, cesium carbonate, lithium hydrogen carbonate, sodium hydrogen carbonate, potassium hydrogen carbonate, rubidium hydrogen carbonate, cesium hydrogen carbonate, sodium acetate, potassium acetate, sodium nitrite, potassium nitrite, sodium sulfite, potassium sulfite, disodium hydrogen phosphate, trisodium phosphate, dipotassium hydrogen phosphate, tripotassium phosphate, lithium borate, sodium borate, potassium borate, rubidium borate, cesium borate, sodium octaborate, and potassium tetraborate. Borates such as lithium borate include polyborates such as lithium polyborate.

The basic salt containing an acid having a pKa of 2 or more and an alkali metal is preferably contained at 0.2 mass % or more and 7.5 mass % or less, more preferably contained at 0.3 mass % or more and 5.0 mass % or less, and further preferably contained at 0.5 mass % or more and 3.0 mass % or less with respect to the solid content of the polymer (A).

The basic salt containing an acid having a pKa of 2 or more and an alkali metal can also be confirmed by dissolving a resin cured film (H), which will be described below, in a solvent, measuring the pH thereof, and checking the pH being basic.

The polymer emulsion (B) may contain one or more of a defoaming agent, a filler, a leveling agent, and a solvent.

### <One-Component Thermosetting Resin Composition (F)>

An embodiment of the present invention is a one-component thermosetting resin composition (F) containing the polymer emulsion (B), in which the polymer emulsion (B) contains the constituent unit (A-2), and at least one hydrogen atom of R⁶ in the constituent unit (A-2) is replaced by a hydroxy group. The constituent unit (A-2) is contained, and at least one hydrogen atom of R⁶ in the constituent unit (A-2) is replaced by a hydroxy group, whereby a transesterification reaction with R³ in the constituent unit (A-1) is performed, and crosslinking can be performed. The one-component thermosetting resin composition (F) may contain, for example, a pigment, a dye, an anti-aging agent, a thickener, and a filler if necessary. The one-component thermosetting resin composition (F) can be preferably used as a coating material (G).

### <Resin Cured Film (H)>

An embodiment of the present invention is a resin cured film (H) obtained by curing the one-component thermosetting resin composition (F). The resin cured film (H) can be obtained by thermally curing the one-component thermosetting resin composition (F) by a known method. The resin cured film (H) is thought to be formed by a hydroxy group derived from the constituent unit (A-2) crosslinking in the polymer (A) or between the polymers (A). The temperature during the thermal curing is preferably 60° C. or higher, more preferably 70° C. or higher, and further preferably 90° C. or higher, and is preferably lower than 150° C., and more preferably 135° C. or lower.

The resin cured film (H) can be preferably used as, for example, a coating film (I), a coating agent and an adhesive.

### <Two-Component Thermosetting Resin Composition (K)>

An embodiment of the present invention is a two-component thermosetting resin composition (K) containing the polymer emulsion (B) and an acrylic polyol polymer emulsion (J), which will be described below. The polymer emulsion (B) and the acrylic polyol polymer emulsion (J) are each separately prepared, then, mixed and used, or stored in separate containers until being used. The two-component thermosetting resin composition (K) can be preferably used as a coating material (L).

### [Acrylic Polyol Polymer Emulsion (J)]

The acrylic polyol polymer emulsion (J) is not limited, and a known acrylic polyol polymer emulsion can be used with no limitations, but an emulsion containing an acrylic polyol copolymer represented by the following formula (8) is preferable.

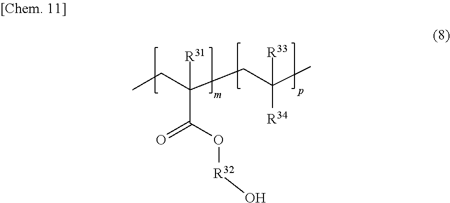

In formula (8), R³¹ and R³³ each independently represent a hydrogen atom, or an aliphatic saturated hydrocarbon group having 1 to 6 carbon atoms, preferably having 1 to 4 carbon atoms, and containing a straight chain or a branched chain, and R³² represents a divalent aliphatic saturated hydrocarbon group having 1 to 20 carbon atoms, preferably having 1 to 8 carbon atoms, and optionally having an ester bond and/or a carbonyl group, or an aromatic hydrocarbon group having 6 to 20 carbon atoms, preferably having 6 to 10 carbon atoms. R³⁴ represents a hydrocarbon group having 1 to 20 carbon atoms, preferably having 1 to 8 carbon atoms. m represents an integer of 1 or more, and p represents an integer of 0 or 1 or more.

The acrylic polyol polymer emulsion (J) can be obtained by, for example, copolymerizing a mixture containing a hydroxyl group-containing polymerizable unsaturated monomer and further polymerizable unsaturated monomer capable of being copolymerized with the hydroxyl group-containing polymerizable unsaturated monomer, by a known method, for example, a method such as a bulk polymerization method, a method of solution polymerization in an organic solvent, or a method of emulsion polymerization in water.

Examples of the hydroxyl group-containing polymerizable unsaturated monomer include a monoester of a polyhydric alcohol and (meth)acrylic acid, such as 2-hydroxyethyl (meth)acrylate, 2-hydroxypropyl (meth)acrylate, 3-hydroxypropyl (meth)acrylate, 3-hydroxyphenyl (meth)acrylate, 4-hydroxybutyl (meth)acrylate, 6-hydroxyhexyl (meth)acrylate, mono-2-((meth)acryloyloxy)ethylsuccinic acid, polyethylene glycol mono(meth)acrylate or polypropylene glycol (meth)acrylate, and a compound obtained by ring-opening polymerization of ε-caprolactone with the monoester of the polyhydric alcohol and (meth)acrylic acid, and these can be used singly, or in combination of two or more thereof. Of these, 2-hydroxyethyl (meth)acrylate can be preferably used.

Examples of the further polymerizable unsaturated monomer capable of being copolymerized include alkyl esters of (meth)acrylic acid such as methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, 2-ethylhexyl acrylate, cyclohexyl (meth)acrylate, n-octyl (meth)acrylate, lauryl (meth)acrylate, isobornyl (meth)acrylate and stearyl (meth)acrylate; carboxyl group-containing polymerizable unsaturated monomers such as (meth)acrylic acid, maleic acid and maleic anhydride; aminoalkyl (meth)acrylates such as N,N-dimethylaminoethyl (meth)acrylate, N,N-diethylaminoethyl (meth)acrylate and N,N-dimethylaminopropyl (meth)acrylate; (meth)acrylamide or derivatives thereof such as acrylamide, methacrylamide, N,N-dimethylaminoethyl (meth)acrylamide, N,N-diethylaminoethyl (meth)acrylamide, N,N-dimethylaminopropyl (meth)acrylamide, N-methylol acrylamide, N-methylol acrylamide methyl ether and N-methylol acrylamide butyl ether; quaternary ammonium base-containing monomers such as 2-(methacryloyloxy)ethyltrimethylammonium chloride and 2-(methacryloyloxy)ethyltrimethylammonium bromide; sulfoalkyl (meth)acrylates such as (meth)acrylamide-alkanesulfonic acids such as 2-acrylamide-2-methylpropanesulfonic acid, and 2-sulfoethyl (meth)acrylate; acrylonitrile, methacrylonitrile, vinyl acetate, styrene, vinyl toluene and α-methylstyrene; polyvinyl compounds such as allyl methacrylate; and hydrolyzable silyl group-containing polymerizable unsaturated monomers such as γ-(meth)acryloyloxypropyl trimethoxysilane, γ-(meth)acryloyloxypropyl triethoxysilane and γ-(meth)acryloyloxypropylmethyl dimethoxysilane. These can be used singly, or in combination of two or more thereof. Of these, (meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, 2-ethylhexyl acrylate, and cyclohexyl (meth)acrylate can be preferably used.

The mixing ratio between the polymer emulsion (B) and the acrylic polyol polymer emulsion (J):(number of moles of R³ in constituent unit (A-1) in polymer emulsion (B)):(number of moles of hydroxyl groups in acrylic polyol polymer emulsion (J)) is preferably 10:1 to 1:10, more preferably 5:1 to 1:5, further preferably 2:1 to 1:4, particularly preferably 1.25:1 to 1:1.25, and most preferably 1.1:1 to 1:1.1.

The two-component thermosetting resin composition (K) may contain, for example, a pigment, a dye, an anti-aging agent, a thickener, a filler and a film formation auxiliary agent if necessary.

### <Resin Cured Film (M)>

An embodiment of the present invention is a resin cured film (M) obtained by curing the two-component thermosetting resin composition (K). The resin cured film (M) can be obtained by mixing the prepared polymer emulsion (B) and the acrylic polyol polymer emulsion (J), and then thermally curing the mixture by a known method. The temperature during the thermal curing is preferably 60° C. or higher, more preferably 70° C. or higher, and further preferably 90° C. or higher, and is preferably lower than 130° C., and more preferably 125° C. or lower. The resin cured film (M) is thought to be formed by crosslinking of R³ in the constituent unit (A-1) in the polymer emulsion (B) and an acrylic polyol polymer in the acrylic polyol polymer emulsion (J).

The resin cured film (M) of the present aspect can be preferably used as, for example, a coating film (N), a coating agent and an adhesive.

### EXAMPLES

Hereinafter, the present invention will be further specifically described with reference to Examples and Comparative Examples, but it should be understood that the present invention is not limited to Examples below.

### [Evaluation of Solid Content]

The solid content concentration in a polymer emulsion was calculated from a difference between the mass before drying and the mass after drying by precisely weighing the polymer emulsion on an aluminum dish, and then drying the polymer emulsion by performing heat treatment (at 141° C. for 30 minutes) to leave only the solid content.

### [Measurement of Molecular Weight]

To about 0.1 g of the emulsion, 1.5 mL of tetrahydrofuran was added, the mixture was then manually shaken to dissolve the emulsion, and the number average molecular weight (Mn) and the weight average molecular weight (Mw) of the polymer in the polymer emulsion were measured by a gel permeation chromatography (GPC) method, and calculated in terms of polystyrene.

### [Evaluation of Tensile Strength (Tb), Elongation at Break (Eb), Modulus at 100% Elongation (M100), Modulus at 300% Elongation (M300) and Modulus at 500% Elongation (M500) for Film]

The resin dried film or resin cured film obtained in each of Examples or Comparative Examples was peeled from a glass substrate, and then cut into a No. 8 dumbbell type. Each film cut out was subjected to a tensile test using a tension and compression tester (AUTOGRAPH AGS-500 NX manufacture by Shimadzu Corporation; tension rate: 50 mm/min, temperature: 23° C.). The tensile test was conducted by a method conforming to JIS-K 7127-1999. By the present test, a modulus at 100% elongation (M100), a modulus at 300% elongation (M300), a modulus at 500% elongation (M500), a tensile strength (Tb) and an elongation at break (Eb) were measured at room temperature.

### [Stability Test]

The block group decomposition rates were measured by the following measurement method immediately after the preparation of the polymer emulsion, after the polymer emulsion was stored for two weeks, one month, two months, and six months at 25° C., and after the polymer emulsion was stored for six weeks at 40° C.

The tensile strengths (Tb), elongation at break (Eb), moduli at 100% elongation (M100), moduli at 300% elongation (M300), and moduli at 500% elongation (M500) of the resin dried film and the resin cured film immediately after being prepared and after being stored for one week, two weeks, and four weeks at 40° C. were measured by the above-described measurement method.

### [Block Group Decomposition Rate]

The decomposition rate of a block group derived from a blocking agent in a constituent unit (A-1) was obtained from the amount of an alcohol, such as ethanol, generated by the decomposition of the block group after storage when the theoretical value of the amount of the alcohol, such as ethanol, that was generated in a case where (A-1) contained in the polymer emulsion was fully decomposed was used as a criterion (100%). About 10 g of cyclohexane and about 0.1 g of an internal standard (o-dichlorobenzene) were precisely weighed in a glass vial bottle, then, 1 g of the polymer emulsion was precisely weighed thereon, the lid was closed, the components were shaken for 30 seconds and then placed still for five minutes, and a supernatant liquid was analyzed by gas chromatography (GC) (a peak of the alcohol, such as ethanol, was detected).
Analysis condition: Gas chromatography Agilent 6850 (manufactured by Agilent Technologies)
Detector: Flame ionization detector (FID)
Column: DB-1 (part No.: 123-1033, manufactured by Agilent Technologies
inner diameter: 0.32 mm, length: 30 m, film thickness: 1 μm)
Analysis condition: The column temperature was raised up to 300° C. from 70° C. at the beginning at a heating rate of 20° C./min and then held for three minutes.

### [Gel Content]

The resin dried film or resin cured film obtained in each of Examples or Comparative Examples was peeled from a glass substrate, and then about 0.5 g was cut off and precisely weighed. The mass of this was regarded as the mass before dispersion. The film was added to 100 ml of acetone and dispersed by being shaken overnight. Filtration was performed after the dispersion, and a filtered solid was dried at 105° C. for 30 minutes. This was regarded as the mass after filtration. The gel content was measured by the following formula. Gel content (mass %)=((mass before dispersion)−(mass after filtration))÷(mass before dispersion)×100

### [Reagents Used]

Abbreviations of compounds used in Examples and Comparative Examples are shown below.

### [Constituent Unit (A-1)]

MOI-OBE: KARENZ® MOI-OBE (reaction product of 2-isocyanatoethyl methacrylate and ethyl acetoacetate, 2-[(1-(ethoxycarbonyl)-2-oxypropyl)carbonylamino]ethyl methacrylate, manufactured by Showa Denko Materials Co., Ltd.)
MOI-OBM: KARENZ® MOI-OBM (reaction product of 2-isocyanatoethyl methacrylate and methyl acetoacetate, 2-[(1-(methoxycarbonyl)-2-oxypropyl)carbonylamino]ethyl methacrylate, manufactured by Showa Denko Materials Co., Ltd.)

### [Constituent Unit (A-2)]

BuA: Butyl acrylate (manufactured by Kanto Chemical Co., Inc.)
MMA: Methyl methacrylate (manufactured by Kanto Chemical Co., Inc.)
HEMA: 2-Hydroxyethyl methacrylate (manufactured by Kanto Chemical Co., Inc.)

### [Constituent Unit (A-3)]

Aa: Acrylic acid (manufactured by Kanto Chemical Co., Inc.)
AOI-DEM: KARENZ® AOI-DEM (reaction product of 2-isocyanatoethyl acrylate and diethyl malonate, malonic acid-2-[[[[2-[1-oxo-2-propenyl]oxy]ethyl]amino]carbonyl]-1,3-diethyl ester, manufactured by Showa Denko Materials Co., Ltd.)

### [Other Components]

NaSS: Sodium styrenesulfonate (manufactured by Tokyo Chemical Industry Co., Ltd.)

### [Surfactant]

KH-10: AQUALON® KH-10 (manufactured by DKS Co. Ltd.) [chain transfer agent]
OTG: 2-Ethylhexyl thioglycolate (manufactured by FUJIFILM Wako Pure Chemical Corporation)

### [Polymerization Initiator]

KPS: Potassium persulfate (manufactured by Kanto Chemical Co., Inc.)

### [Reducing Agent]

SBS: Sodium bisulfite (manufactured by Kanto Chemical Co., Inc.)

### Preparation Example 1

An acrylic polyol polymer emulsion was prepared as follow.

A 1 L four-neck flask equipped with a stirrer, a condenser and a thermometer was charged with 120 g of deionized water, and heated to 80° C. in a water bath while the inside of the system was purged with nitrogen gas. Separately, a 500 mL glass beaker was charged with 1.0 g of sodium p-styrene sulfonate, 60 g of methyl methacrylate, 90 g of butyl acrylate, 9 g of butyl methacrylate, 20 g of 2-hydroxyethyl methacrylate, 20 g of styrene, 1.6 g of 2-ethylhexyl thioglycolate, 100 g of deionized water, and 3.0 g of AQUALON® KH-10, and the mixture was vigorously stirred with a stirrer chip to prepare an emulsified liquid. To a container heated to 80° C. was added 30 g of the prepared emulsified liquid, and a separately prepared catalyst liquid A (0.60 g of potassium persulfate, 11.4 g of deionized water) was then added at a time. 30 minutes after the addition, the remaining emulsified liquid was added over 3 hours, and simultaneously, a separately prepared catalyst liquid B (60 mg of potassium persulfate, 1.1 g of deionized water) was added over 3 hours. After completion of the addition of the catalyst liquid B, the mixture was further aged for 1.5 hours. After completion of the aging, the aged product was cooled to 30° C. or lower, and neutralized with aqueous ammonia to a pH of 7.5 or higher to obtain an intended acrylic polyol polymer emulsion. The solid content concentration was 47.0 mass %.

### Example 1

A two-component thermosetting resin composition and a resin cured film were prepared as follows.

A 500 mL four-neck flask equipped with a stirrer, a condenser and a thermometer was charged with 35.5 g of deionized water, 0.05 g of AQUALON® KH-10, and 235 mg of sodium bisulfite, and heated to 50° C. in a water bath while the inside of the system was purged with nitrogen gas. Separately, a 300 mL glass beaker was charged with 1.40 g of acrylic acid, 49.0 g of butyl acrylate, 40.1 g of methyl methacrylate, 9.5 g of 2-[(1-(methoxycarbonyl)-2-oxypropyl)carbonylamino]ethyl methacrylate (MOI-OBE), 0.68 g of 2-ethylhexyl thioglycolate, 55.0 g of deionized water, and 5.0 g of AQUALON® KH-10, and the mixture was vigorously stirred with a stirrer chip to prepare an emulsified liquid. To a container heated to 50° C. was added 16 g of the prepared emulsified liquid, and a separately prepared catalyst liquid A (0.13 g of potassium persulfate, 2.5 g of deionized water) was then added at a time. 30 minutes after the addition, the remaining emulsified liquid was added over 4 hours, and simultaneously, a separately prepared catalyst liquid B (0.13 g of potassium persulfate, 2.5 g of deionized water) was added over 4 hours. After completion of the addition of the emulsified liquid and the catalyst liquid B, the mixture was further aged for 1.5 hours. After completion of the aging, the aged product was cooled to 30° C. or lower, and neutralized with aqueous ammonia to a pH of 7.5 or higher to obtain an intended polymer emulsion. No residual monomer was detected in the polymer emulsion except for 3,400 ppm of n-butyl acrylate, and thus it was confirmed that the composition of the copolymer charged was substantially identical to the composition of monomers charged. The solid content concentration was 46.36 mass %.

The obtained polymer emulsion and the acrylic polyol polymer emulsion obtained in Preparation Example 1 were mixed together for 30 minutes in a composition for making a film shown in Table 1-1, and a two-component thermosetting resin composition was obtained.

The obtained two-component thermosetting resin composition was applied to 50±20 μm onto a glass substrate coated with a mold release agent, and was dried at 23° C. for one hour or longer to obtain a resin dried film. The two-component thermosetting resin composition was applied to 50±20 μm onto a glass substrate coated with a mold release agent, and was cured at 120° C. for 15 minutes to obtain a resin cured film. The described storage time is a time during which the polymer emulsion was stored at a temperature for a time shown in Table 2-1.

### Examples 2 to 6, Examples 8 and 9, and Comparative Examples 1 and 2

Polymer emulsions were prepared in the same manner as in Example 1 except that the compositions were changed as shown in Table 1-1 to Table 1-3, these and the acrylic polyol polymer emulsion obtained in Preparation Example 1 were mixed together for 30 minutes in compositions for making a film shown in Table 1-1 to Table 1-3, and two-component thermosetting resin compositions of Examples 2 to 6, 8, and 9, and Comparative Examples 1 and 2 were obtained. A resin dried film and a resin cured film were obtained in the same manner as in Example 1 using each of the obtained two-component thermosetting resin compositions.

### Example 7

A copolymer emulsion was prepared in the same manner as in Example 6 except that the composition was changed as shown in Table 1-2, and a one-component thermosetting resin composition of Example 7 was obtained in the same manner as in Example 6 except that the acrylic polyol polymer emulsion was not used. A resin dried film and a resin cured film were obtained in the same manner as in Example 6 using the obtained one-component thermosetting resin composition.

Table 2-1 to Table 2-4 show the results of evaluation and measurement in Examples 1 to 9 and Comparative Examples 1 and 2.

TABLE 1-1
(Parts by mass)

| | | | | Example 1 | Example 2 | Example 3 | Example 4 |
|---|---|---|---|---|---|---|---|
| Polymerization | Monomer | A-1 | MOI-OBE | 9.47 | | 50 | 2.5 |
| composition | | | (MOI-OBE(mol %)) | 4.0 | | 28.2 | 1.0 |
| | | | MOI-OBM | | 9 | | |
| | | | (MOI-OBM(mol %)) | | 4.0 | | |
| | | A-2 | BuA | 49.02 | 49.3 | 27.1 | 52.6 |
| | | | (BuA(mol %)) | 45.8 | 45.8 | 34.1 | 47.0 |
| | | | MMA | 40.11 | 40.3 | 21.5 | 43.5 |
| | | | (MMA(mol %)) | 47.9 | 47.9 | 34.6 | 49.8 |
| | | | HEMA | | | | |
| | | | (HEMA(mol %)) | | | | |
| | | A-3 | Aa | 1.4 | 1.4 | 1.4 | 1.4 |
| | | | (Aa(mol %)) | 2.3 | 2.3 | 3.1 | 2.2 |
| | | Others | AOI-DEM | | | | |
| | | | (AOI-DEM(mol %)) | | | | |
| | Chain | Chain | OTG | 0.6783 | 0.6816 | 0.5039 | 0.7086 |
| | transfer | transfer | | | | | |
| | agent | agent | | | | | |
| | Water | Surfactant | KH-10 | 5 | 5 | 5 | 5 |
| | layer | | Deionized water | 108.93 | 108.93 | 108.93 | 108.93 |
| | | Salt | Sodium hydrogen | | | | |
| | | | carbonate | | | | |
| Functional group equivalent | | | | 3013 | 3014 | 571 | 11412 |
| Functional group equivalent ÷ Mn | | | | 0.084 | 0.091 | 0.015 | 0.535 |
| Emulsion | Solid | (%) | | 46.36 | 47.27 | 44.50 | 46.10 |
| | content | | | | | | |
| | concentration | | | | | | |

| | | | | | |
|---|---|---|---|---|---|
| Polymer | Mn | 35,721 | 33,011 | 38,424 | 21,348 |
| molecular | Mw | 65,736 | 67,921 | 76,526 | 39,345 |
| weight | Mw/Mn | 1.84 | 2.06 | 1.99 | 1.84 |

| | | | | | | |
|---|---|---|---|---|---|---|
| Composition | Polymer emulsion | (g) | 20 | 20 | 7 | 20 |
| for making | Acrylic polyol | (g) | 9.5 | 9.3 | 18 | 2.5 |
| film | polymer emulsion | | | | | |

n/a: Not measured
N/A: Not measurable

TABLE 1-2
(Parts by mass)

| | | | | Example 5 | Example 6 | Example 7 | Example 8 |
|---|---|---|---|---|---|---|---|
| Polymerization | Monomer | A-1 | MOI-OBE | 0.5 | 9.47 | 9.47 | 0.5 |
| composition | | | (MOI-OBE(mol %)) | 0.2 | 4.0 | 4.0 | 0.2 |
| | | | MOI-OBM | | | | |
| | | | (MOI-OBM(mol %)) | | | | |
| | | A-2 | BuA | 53.6 | 46.23 | 46.23 | 53.6 |
| | | | (BuA(mol %)) | 47.3 | 43.4 | 43.4 | 47.3 |
| | | | MMA | 44.5 | 38.5 | 38.5 | 44.5 |
| | | | (MMA(mol %)) | 50.3 | 46.2 | 46.2 | 50.3 |
| | | | HEMA | | 4.4 | 4.4 | |
| | | | (HEMA(mol %)) | | 4.1 | 4.1 | |
| | | A-3 | Aa | 1.4 | 1.4 | 1.4 | 1.4 |
| | | | (Aa(mol %)) | 2.2 | 2.3 | 2.3 | 2.2 |
| | | Others | AOI-DEM | | | | |
| | | | (AOI-DEM(mol %)) | | | | |
| | Chain | Chain | OTG | 0.0897 | 0.6475 | 0.6475 | 0.3587 |
| | transfer | transfer | | | | | |
| | agent | agent | | | | | |
| | Water | Surfactant | KH-10 | 5 | 5 | 5 | 5 |
| | layer | | Deionized water | 108.93 | 108.93 | 108.93 | 108.93 |
| | | Salt | Sodium hydrogen | | | | |
| | | | carbonate | | | | |
| Functional group equivalent | | | | 57059 | 3013 | 3013 | 57059 |
| Functional group equivalent ÷ Mn | | | | 0.453 | 0.084 | 0.084 | 1.009 |
| Emulsion | Solid | (%) | | 48.19 | 46.68 | 46.68 | 48.51 |
| | content | | | | | | |
| | concentration | | | | | | |

| | | | | | |
|---|---|---|---|---|---|
| Polymer | Mn | 126,034 | 35,834 | 35,834 | 56,567 |
| molecular | Mw | 355,835 | 69,027 | 69,027 | 118,135 |
| weight | Mw/Mn | 2.82 | 1.93 | 1.93 | 2.09 |

| | | | | | | |
|---|---|---|---|---|---|---|
| Composition | Polymer emulsion | (g) | 20 | 20 | 20 | 20 |
| for making | Acrylic polyol | (g) | 0.5 | 9.5 | 0.0 | 0.5 |
| film | polymer emulsion | | | | | |

n/a: Not measured
N/A: Not measurable

TABLE 1-3
(Parts by mass)

| | | | | | Comparative | Comparative |
|---|---|---|---|---|---|---|
| | | | | Example 9 | Example 1 | Example 2 |
| Polymerization | Monomer | A-1 | MOI-OBE | 9.47 | | |
| composition | | | (MOI-OBE(mol %)) | 4.0 | | |
| | | | MOI-OBM | | | |
| | | | (MOI-OBM(mol %)) | | | |
| | | A-2 | BuA | 49.02 | 49.15 | 21.6 |
| | | | (BuA(mol %)) | 45.8 | 46.2 | 18.9 |
| | | | MMA | 40.11 | 39.45 | 67 |
| | | | (MMA(mol %)) | 47.9 | 47.5 | 75.2 |
| | | | HEMA | | | |
| | | | (HEMA(mol %)) | | | |
| | | A-3 | Aa | 1.4 | 1.4 | 1.4 |
| | | | (Aa(mol %)) | 2.3 | 2.3 | 2.2 |
| | | Others | AOI-DEM | | 10 | 10 |
| | | | (AOI-DEM(mol %)) | | 4.0 | 3.7 |
| | Chain | Chain | OTG | 0.6783 | 0.6432 | 0.7226 |
| | transfer | transfer | | | | |
| | agent | agent | | | | |
| | Water layer | Surfactant | KH-10 | 5 | 5 | 5 |
| | | | Deionized water | 108.93 | 108.93 | 108.93 |
| | | Salt | Sodium hydrogen | 0.19 | | |
| | | | carbonate | | | |
| Functional group equivalent | | | | 3013 | 3153 | 3153 |
| Functional group equivalent ÷ Mn | | | | 0.084 | 0.113 | 0.121 |
| Emulsion | Solid | (%) | | 46.71 | 48.21 | 48.11 |
| | content | | | | | |
| | concentration | | | | | |

| | | | | |
|---|---|---|---|---|
| Polymer | Mn | 35,721 | 27,956 | 26,022 |
| molecular | Mw | 65,736 | 54,779 | 48,837 |
| weight | Mw/Mn | 1.84 | 1.96 | 1.88 |

| | | | | | |
|---|---|---|---|---|---|
| Composition | Polymer emulsion | (g) | 20 | 20 | 20 |
| for making | Acrylic polyol | (g) | 9.5 | 9.1 | 9.3 |
| film | polymer emulsion | | | | |

n/a: Not measured
N/A: Not measurable

TABLE 2-1

| | | | Example 1 | Example 1 | Example 1 |
|---|---|---|---|---|---|
| Block group | Immediately after synthesis | | 0% | 0% | 1% |
| decomposition rate | Storage | After 14 days | 0% | 0% | 1% |
| | stability | After one month | 0% | 0% | 2% |
| | (25° C.) | After two | 0% | n/a | n/a |
| | | months | | | |
| | | After six months | n/a | n/a | n/a |
| | Storage | After six weeks | 2% | n/a | n/a |
| | stability | | | | |
| | (40° C.) | | | | |
| Resin dried film evaluation | Tb | (MPa) | N/A | N/A | N/A |
| (immediately after polymer | Eb | (%) | No break | No break | No break |
| emulsion synthesis) | | | (more than | (more than | (more than |
| (during room temperature | | | 800) | 800) | 800) |
| drying) | M100 | (MPa) | 0.4 | 0.5 | 1.3 |
| | M300 | (MPa) | 0.7 | 0.7 | 1.4 |
| | M500 | (MPa) | 0.9 | 0.9 | 1.3 |
| | Gel content | (%) | 4.1 | 3.0 | 5.0 |
| Resin cured film | Tb | (MPa) | 15.1 | 12.7 | 16.3 |
| evaluation (immediately | Eb | (%) | 182 | 187 | 106 |
| after polymer emulsion | M100 | (MPa) | 4.7 | 3.6 | 15.0 |
| synthesis) (120° C., 15 | M300 | (MPa) | N/A | N/A | N/A |
| minutes) | M500 | (MPa) | N/A | N/A | N/A |
| | Gel content | (%) | 95.6 | 94.2 | 96.8 |
| Resin cured film | Tb | (MPa) | n/a | n/a | 12.4 |
| evaluation (after four-week | Eb | (%) | n/a | n/a | 97 |
| storage of polymer | M100 | (MPa) | n/a | n/a | 12.0 |
| emulsion at 25° C.) (120° C., | M300 | (MPa) | n/a | n/a | N/A |
| 15 minutes) | M500 | (MPa) | n/a | n/a | N/A |
| | Gel content | (%) | n/a | n/a | 97.2 |
| Resin cured film | Tb | (MPa) | n/a | n/a | n/a |
| evaluation (after six-month | Eb | (%) | n/a | n/a | n/a |
| storage of polymer | M100 | (MPa) | n/a | n/a | n/a |
| emulsion at 25° C.) (120° C., | M300 | (MPa) | n/a | n/a | n/a |
| 15 minutes) | M500 | (MPa) | n/a | n/a | n/a |
| | Gel content | (%) | n/a | n/a | n/a |
| Resin cured film | Tb | (MPa) | 14.7 | n/a | n/a |
| evaluation (after six-week | Eb | (%) | 203 | n/a | n/a |
| storage of polymer | M100 | (MPa) | 3.7 | n/a | n/a |
| emulsion at 40° C.) (120° C., | M300 | (MPa) | N/A | n/a | n/a |
| 15 minutes) | M500 | (MPa) | N/A | n/a | n/a |
| | Gel content | (%) | n/a | n/a | n/a |

n/a: Not measured
N/A: Not measurable

TABLE 2-2

| | | | Example 4 | Example 5 | Example 6 |
|---|---|---|---|---|---|
| Block group | Immediately after synthesis | | 0% | 0% | 0% |
| decomposition rate | Storage | After 14 days | 0% | 0% | 0% |
| | stability | After one month | 0% | 0% | 0% |
| | (25° C.) | After two months | n/a | n/a | n/a |
| | | After six months | n/a | n/a | n/a |
| | Storage | After six weeks | n/a | n/a | n/a |
| | stability | | | | |
| | (40° C.) | | | | |
| Resin dried film evaluation | Tb | (MPa) | n/a | 2.1 | N/A |
| (immediately after polymer | Eb | (%) | n/a | 757 | No break |
| emulsion synthesis) | | | | | (more than |
| (during room temperature | | | | | 800) |
| drying) | M100 | (MPa) | n/a | 0.5 | 0.4 |
| | M300 | (MPa) | n/a | 1.0 | 0.4 |
| | M500 | (MPa) | n/a | 1.6 | 0.5 |
| | Gel content | (%) | n/a | 3.9 | 4.4 |
| Resin cured film | Tb | (MPa) | 2.8 | 7.1 | 9.87 |
| evaluation (immediately | Eb | (%) | 490 | 663 | 157 |
| after polymer emulsion | M100 | (MPa) | 0.2 | 0.5 | 3.18 |
| synthesis) (120° C., 15 | M300 | (MPa) | 0.5 | 1.1 | N/A |
| minutes) | M500 | (MPa) | N/A | 2.5 | N/A |
| | Gel content | (%) | n/a | 44.0 | 95.4 |
| Resin cured film | Tb | (MPa) | 3.2 | n/a | n/a |
| evaluation (after four-week | Eb | (%) | 473 | n/a | n/a |
| storage of polymer | M100 | (MPa) | 0.3 | n/a | n/a |
| emulsion at 25° C.) (120° C., | M300 | (MPa) | 0.7 | n/a | n/a |
| 15 minutes) | M500 | (MPa) | N/A | n/a | n/a |
| | Gel content | (%) | 67.4 | n/a | n/a |
| Resin cured film | Tb | (MPa) | n/a | n/a | n/a |
| evaluation (after six-month | Eb | (%) | n/a | n/a | n/a |
| storage of polymer | M100 | (MPa) | n/a | n/a | n/a |
| emulsion at 25° C.) (120° C., | M300 | (MPa) | n/a | n/a | n/a |
| 15 minutes) | M500 | (MPa) | n/a | n/a | n/a |
| | Gel content | (%) | n/a | n/a | n/a |
| Resin cured film | Tb | (MPa) | n/a | n/a | n/a |
| evaluation (after six-week | Eb | (%) | n/a | n/a | n/a |
| storage of polymer | M100 | (MPa) | n/a | n/a | n/a |
| emulsion at 40° C.) (120° C., | M300 | (MPa) | n/a | n/a | n/a |
| 15 minutes) | M500 | (MPa) | n/a | n/a | n/a |
| | Gel content | (%) | n/a | n/a | n/a |

n/a: Not measured
N/A: Not measurable

TABLE 2-3

| | | | Example 7 | Example 8 | Example 9 |
|---|---|---|---|---|---|
| Block group | Immediately after synthesis | | 0% | 0% | 0% |
| decomposition rate | Storage | After 14 days | 0% | 0% | 0% |
| | stability | After one month | 0% | 0% | 0% |
| | (25° C.) | After two | n/a | n/a | n/a |
| | | months | | | |
| | | After six months | n/a | n/a | n/a |
| | Storage | After six weeks | n/a | n/a | n/a |
| | stability | | | | |
| | (40° C.) | | | | |
| Resin dried film evaluation | Tb | (MPa) | N/A | N/A | N/A |
| (immediately after polymer | Eb | (%) | No break | No break | No break |
| emulsion synthesis) | | | (more than | (more than | (more than |
| (during room temperature | | | 800) | 800) | 800) |
| drying) | M100 | (MPa) | 0.3 | 0.5 | 0.5 |
| | M300 | (MPa) | 0.4 | 0.6 | 0.8 |
| | M500 | (MPa) | 0.4 | 0.6 | 1.0 |
| | Gel content | (%) | 5.2 | 3.9 | 3.4 |
| Resin cured film | Tb | (MPa) | 11.4 | N/A | 10.7 |
| evaluation (immediately | Eb | (%) | 150 | No break | 204 |
| after polymer emulsion | | | | (more than | |
| synthesis) (120° C., 15 | | | | 800) | |
| minutes) | M100 | (MPa) | 3.8 | 0.4 | 2.7 |
| | M300 | (MPa) | N/A | 0.6 | N/A |
| | M500 | (MPa) | N/A | 0.9 | N/A |
| | Gel content | (%) | 96.2 | 44.4 | 6.4 |
| Resin cured film | Tb | (MPa) | n/a | N/A | n/a |
| evaluation (after four-week | Eb | (%) | n/a | No break | n/a |
| storage of polymer | | | | (more than | |
| emulsion at 25° C.) (120° C., | | | | 800) | |
| 15 minutes) | M100 | (MPa) | n/a | 0.4 | n/a |
| | M300 | (MPa) | n/a | 0.7 | n/a |
| | M500 | (MPa) | n/a | 1.1 | n/a |
| | Gel content | (%) | n/a | 8.2 | n/a |
| Resin cured film | Tb | (MPa) | n/a | n/a | n/a |
| evaluation (after six-month | Eb | (%) | n/a | n/a | n/a |
| storage of polymer | M100 | (MPa) | n/a | n/a | n/a |
| emulsion at 25° C.) (120° C., | M300 | (MPa) | n/a | n/a | n/a |
| 15 minutes) | M500 | (MPa) | n/a | n/a | n/a |
| | Gel content | (%) | n/a | n/a | n/a |
| Resin cured film | Tb | (MPa) | n/a | n/a | n/a |
| evaluation (after six-week | Eb | (%) | n/a | n/a | n/a |
| storage of polymer | M100 | (MPa) | n/a | n/a | n/a |
| emulsion at 40° C.) (120° C., | M300 | (MPa) | n/a | n/a | n/a |
| 15 minutes) | M500 | (MPa) | n/a | n/a | n/a |
| | Gel content | (%) | n/a | n/a | n/a |

n/a: Not measured
N/A: Not measurable

TABLE 2-4

| | | | Comparative | Comparative |
|---|---|---|---|---|
| | | | Example 1 | Example 2 |
| Block group decomposition rate | Immediately after synthesis | | 18% | 9% |
| | Storage stability | After 14 days | 27% | 12% |
| | (25° C.) | After one month | 50% | 12% |
| | | After two months | 79% | 22% |
| | | After six months | n/a | 79% |
| | Storage stability | After six weeks | n/a | n/a |
| | (40° C.) | | | |
| Resin dried film evaluation | Tb | (MPa) | N/A | 8.2 |
| (immediately after polymer | Eb | (%) | No break (more | 174 |
| emulsion synthesis) (during | | | than 800) | |
| room temperature drying) | M100 | (MPa) | 0.6 | 7.1 |
| | M300 | (MPa) | 0.7 | N/A |
| | M500 | (MPa) | 0.8 | N/A |
| | Gel content | (%) | 4.1 | 4.1 |
| Resin cured film evaluation | Tb | (MPa) | 9.2 | 18.8 |
| (immediately after polymer | Eb | (%) | 198 | 113 |
| emulsion synthesis) (120° C., 15 | M100 | (MPa) | 2.0 | 17.7 |
| minutes) | M300 | (MPa) | N/A | N/A |
| | M500 | (MPa) | N/A | N/A |
| | Gel content | (%) | 97.4 | 97.1 |
| Resin cured film evaluation | Tb | (MPa) | N/A | 19.1 |
| (after four-week storage of | Eb | (%) | No break (more | 122 |
| polymer emulsion at 25° C.) | | | than 800) | |
| (120° C., 15 minutes) | M100 | (MPa) | 0.7 | 18.6 |
| | M300 | (MPa) | 0.8 | N/A |
| | M500 | (MPa) | 0.8 | N/A |
| | Gel content | (%) | 7.6 | 81.2 |
| Resin cured film evaluation | Tb | (MPa) | n/a | 9.5 |
| (after six-month storage of | Eb | (%) | n/a | 143 |
| polymer emulsion at 25° C.) | M100 | (MPa) | n/a | 7.9 |
| (120° C., 15 minutes) | M300 | (MPa) | n/a | N/A |
| | M500 | (MPa) | n/a | N/A |
| | Gel content | (%) | n/a | n/a |
| Resin cured film evaluation | Tb | (MPa) | n/a | n/a |
| (after six-week storage of | Eb | (%) | n/a | n/a |
| polymer emulsion at 40° C.) | M100 | (MPa) | n/a | n/a |
| (120° C., 15 minutes) | M300 | (MPa) | n/a | n/a |
| | M500 | (MPa) | n/a | n/a |
| | Gel content | (%) | n/a | n/a |

n/a: Not measured
N/A: Not measurable

In the polymer emulsions of Examples, the block group decomposition rates after one month were 5 mass % or less in the preservation stability test at 25° C. On the other hand, in the polymer emulsions of Comparative Examples 1 and 2, the decomposition rates of a block group after 14 days were 10 mass % or more, and the decomposition rates of a block group after two months were 20 mass % or more. This shows that the polymer emulsions of Examples had excellent preservation stability.

For the polymer emulsion of Comparative Example 2, Tb was 18.8 MPa, and Eb was 113% immediately after synthesis, but Tb was 9.5 MPa, and Eb was 143% when the polymer emulsion was stored at 25° C. for six months and then crosslinked.

While it was possible to perform crosslinking itself, when the retention rate of Tb is 50%, the physical properties of the resin cured film rely on the preservation state, and the preservation stability is not sufficient. The retention rate (%) of Tb (Eb) is obtained by (Tb (Eb) after storage)+(Tb (Eb) immediately after synthesis)×100. However, in Example 1, crosslinking was possible with Tb of 14.7 MPa and Eb of 203% after the polymer emulsion was stored at 40° C. for six weeks, which is considered to be identical to storage at 25° C. for six months (in acceleration test). The retention rate of Tb is 97%, the physical properties of the resin cured film do not rely on the preservation state, and the preservation stability is sufficient. While also relying on other physical properties, in an aspect, it is preferable that Eb is 50% to 250%, the retention rate of Eb is 50% to 150%, and the retention rate of Tb is 65% to 135%.

1: A polymer emulsion (B) comprising a polymer (A) containing a constituent unit (A-1) represented by the following formula (1), and water: 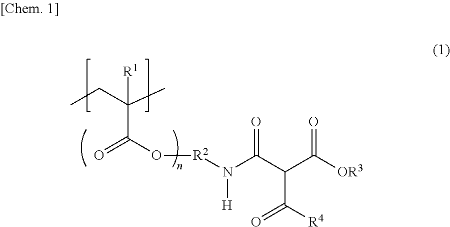
wherein R¹ represents a hydrogen atom or a methyl group, R² represents a di- to tetravalent aliphatic saturated hydrocarbon group having 1 to 20 carbon atoms and containing a straight chain or a branched chain optionally having an ether bond, or a divalent alicyclic hydrocarbon group or aromatic hydrocarbon group having 6 to 20 carbon atoms and optionally having a urethane bond, R³ represents a hydrogen atom, an alkyl group having 1 to 10 carbon atoms, or a cycloalkyl group or arylalkyl group having 6 to 20 carbon atoms, R⁴ represents a hydrogen atom, an alkyl group having 1 to 10 carbon atoms, or a cycloalkyl group or arylalkyl group having 6 to 20 carbon atoms, and n represents 1 or 2.

2: The polymer emulsion (B) according to claim 1, wherein a content ratio of the constituent unit (A-1) when a total content of all constituent units of the polymer (A) is defined as 100 mol % is 0.1 mol % or more and 40 mol % or less.

3: The polymer emulsion (B) according to claim 1, wherein the polymer (A) contains a constituent unit (A-2) represented by the following formula (2) as a constituent unit of the polymer (A): 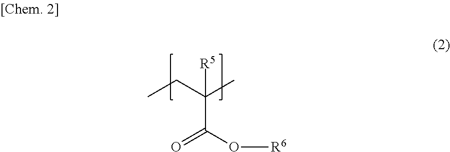
wherein R⁵ represents a hydrogen atom, or an aliphatic saturated hydrocarbon group having 1 to 4 carbon atoms and containing a straight chain or a branched chain; R⁶ represents an aliphatic saturated hydrocarbon group having 1 to 18 carbon atoms in which a hydrogen atom is optionally replaced by a hydroxy group, an acyl group, an alkoxy group, a carboxy group, a thiol group, a sulfo group, a nitro group, an amino group, a chlorine atom, a fluorine atom, a bromine atom, an iodine atom, or an astatine atom, and is free of an aromatic ring.

4: The polymer emulsion (B) according to claim 1, wherein the polymer (A) further contains a constituent unit (A-3) represented by the following formula (3) as a constituent unit of the polymer: 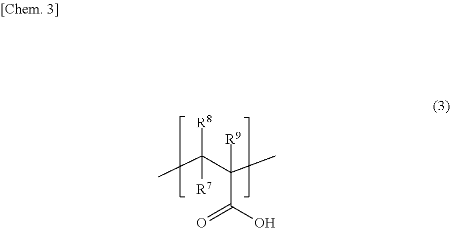
wherein R⁷, R⁸, and R⁹ each independently represent a hydrogen atom, or a hydrocarbon group containing a straight chain or a branched chain having 1 to 15 carbon atoms and optionally containing an ester bond and/or a carboxy group.

5: The polymer emulsion (B) according to claim 1, wherein, in the constituent unit (A-1), n is 1, and R² is a divalent aliphatic saturated hydrocarbon group having 2 to 4 carbon atoms and optionally having an ether bond.

6: A one-component thermosetting resin composition (F) comprising the polymer emulsion (B) according to claim 3, wherein at least one hydrogen atom of R⁶ in the constituent unit (A-2) is replaced by a hydroxy group.

7: A coating material (G) comprising the one-component thermosetting resin composition (F) according to claim 6.

8: A resin cured film (H) obtained by curing the one-component thermosetting resin composition (F) according to claim 6.

9: A coating film (I) comprising the resin cured film (H) according to claim 8.

10: A two-component thermosetting resin composition (K) comprising the polymer emulsion (B) according to claim 1, and an acrylic polyol polymer emulsion (J).

11: The two-component thermosetting resin composition (K) according to claim 10, wherein a ratio between the number of moles of R³ in the constituent unit (A-1) in the polymer emulsion (B) and the number of moles of hydroxyl groups in the acrylic polyol polymer emulsion (J) is 2:1 to 1:4.

12: A coating material (L) comprising the two-component thermosetting resin composition (K) according to claim 10.

13: A resin cured film (M) obtained by curing the two-component thermosetting resin composition (K) according to claim 10.

14: A coating film (N) comprising the resin cured film (M) according to claim 13.
